(19) United States
(12) Patent Application Publication
(10) Pub. No.: US 2025/0190625 A1
(43) Pub. Date: Jun. 12, 2025

(54) PROCESSING APPARATUS, PROCESSING SYSTEM, AND PROCESSING METHOD

(71) Applicant: NEC Corporation, Minato-ku, Tokyo (JP)

(72) Inventors: Kyousuke INAMURA, Tokyo (JP); Jo Yamamoto, Tokyo (JP); Hiroshi Satou, Tokyo (JP); Tomoe Hamatani, Tokyo (JP); Tomoya Hayakawa, Tokyo (JP)

(73) Assignee: NEC Corporation, Minato-ku, Tokyo (JP)

(21) Appl. No.: 18/840,135

(22) PCT Filed: Mar. 4, 2022
(86) PCT No.: PCT/JP2022/009459

§ 371 Date: Aug. 21, 2024

(51) Int. Cl. G06F 21/62

(52) U.S. Cl. CPC G06F 21/629

(57) ABSTRACT

The present invention provides a processing apparatus (100) including: a status information management unit (110) that manages status information in which a current status of each of management target users is registered; a consent information management unit (120) that manages consent information in which determination as to whether to consent to a predetermined consent item is registered for each assumed status in association with each of the management target users; and a decision unit (130) that determines a current status of a first management target user among the management target users, based on the consent information and the status information, decides whether the first management target user consents to the predetermined consent item in a determined status, and issues a predetermined right according to a result of decision.

### TECHNICAL FIELD

The present invention relates to a processing apparatus, a processing system, a processing method, and a storage medium.

### BACKGROUND ART

A technique related to the present invention is disclosed in Patent Document 1. Patent Document 1 discloses a technique in which, in a case where a user consents in advance to transmitting information related to a health state of the user himself/herself to a predetermined transmission destination, information related to the health state of the user is transmitted to the transmission destination at a time when a symptom requiring an emergency has occurred in the user.

### RELATED DOCUMENT

### Patent Document

Patent Document 1: Japanese Patent Application Publication No. 2018-124853

### DISCLOSURE OF THE INVENTION

### Technical Problem

A user is required to choose whether to consent to various consent items related to his/her privacy such as utilization of individual information or determination within a surveillance camera image. Whereas there is a possibility that a user can receive a more considerate service by consenting to these consent items, a risk at which his/her individual information leaks increases. Whether to consent to various consent items related to his/her privacy is a very difficult choice, and a technique of enabling to choose in a more flexible manner has been required, without simply choosing “consent/dissent”.

In a case of the technique disclosed in Patent Document 1, a user can choose, for each transmission destination, whether to consent to transmit his/her information. However, there has been an issue that a user who feels insufficient in a case where the user is simply enabled to choose “consent/dissent” for each transmission destination is present.

In view of the above-described problem, one example of an object of the present invention is to provide a processing apparatus, a processing system, a processing method, and a storage medium that are capable of choosing whether to consent to various consent items related to his/her privacy in a more flexible manner.

### Solution to Problem

One aspect of the present invention provides a processing apparatus including:
a status information management unit that manages status information in which a current status of each of management target users is registered;
a consent information management unit that manages consent information in which determination as to whether to consent to a predetermined consent item is registered for each assumed status in association with each of the management target users; and
a decision unit that determines a current status of a first management target user among the management target users, based on the consent information and the status information, decides whether the first management target user consents to the consent item in a determined status, and issues a predetermined right according to a result of decision.

Further, one aspect of the present invention provides a processing method including,
by a computer:
   managing status information in which a current status of each of management target users is registered;
   managing consent information in which determination as to whether to consent to a predetermined consent item is registered for each assumed status in association with each of the management target users; and
   determining a current status of a first management target user among the management target users, based on the consent information and the status information, deciding whether the first management target user consents to the consent item in a determined status, and issuing a predetermined right according to a result of decision.

Further, one aspect of the present invention provides a storage medium storing a program causing a computer to function as:
a status information management unit that manages status information in which a current status of each of management target users is registered;
a consent information management unit that manages consent information in which determination as to whether to consent to a predetermined consent item is registered for each assumed status in association with each of the management target users; and
a decision unit that determines a current status of a first management target user among the management target users, based on the consent information and the status information, decides whether the first management target user consents to the consent item in a determined status, and issues a predetermined right according to a result of decision.

Further, one aspect of the present invention provides a processing system including:
a status information management unit that manages status information in which a current status of each of management target users is registered;
a consent information management unit that manages consent information in which determination as to whether to consent to a predetermined consent item is registered for each assumed status in association with each of the management target users;
a decision unit that decides whether a first management target user among the management target users consents to the consent item in a current status, based on the consent information and the status information, and issues a predetermined right according to a result of decision; and
a processing unit that performs predetermined processing, based on the predetermined right.

### Advantageous Effects of Invention

According to one aspect of the present invention, a processing apparatus, a processing system, a processing method, and a storage medium that are capable of choosing whether to consent to various consent items related to his/her privacy in a more flexible manner are acquired.

### BRIEF DESCRIPTION OF THE DRAWINGS

The above-described object, the other objects, features, and advantages will become more apparent from public example embodiments described below and the following accompanying drawings.

FIG. 1 It is a diagram illustrating one example of a functional block diagram of a processing apparatus.

FIG. 2 It is a diagram illustrating one example of an overall image of a processing system.

FIG. 3 It is a diagram illustrating one example of a hardware configuration of the processing apparatus and an external apparatus.

FIG. 4 It is a diagram illustrating one example of a functional block diagram of the processing system.

FIG. 5 It is a diagram illustrating one example of a functional block diagram of a status information management unit.

FIG. 6 It is a diagram schematically illustrating one example of status information.

FIG. 7 It is a diagram schematically illustrating one example of information indicating a status change request user with a legitimate right.

FIG. 8 It is a flowchart illustrating one example of a flow of processing of the processing apparatus.

FIG. 9 It is a diagram illustrating one example of a functional block diagram of a consent information management unit.

FIG. 10 It is a diagram schematically illustrating one example of consent information.

FIG. 11 It is a diagram schematically illustrating one example of information indicating a right request user with a legitimate right.

FIG. 12 It is a flowchart illustrating one example of a flow of another piece of processing of the processing apparatus.

FIG. 13 It is a diagram illustrating another example of an overall image of the processing system.

FIG. 14 It is a diagram illustrating another example of an overall image of the processing system.

FIG. 15 It is a diagram illustrating another example of an overall image of the processing system.

FIG. 16 It is a diagram illustrating another example of an overall image of the processing system.

### EXAMPLE EMBODIMENT

Hereinafter, example embodiments according to the present invention are described by using the drawings. Note that, in all drawings, a similar constituent element is indicated by a similar reference sign, and description thereof is omitted as necessary.

### First Example Embodiment

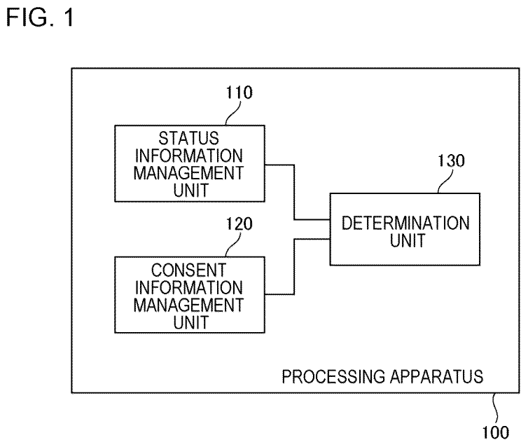

FIG. 1 is a functional block diagram illustrating an overview of a processing apparatus 100 according to a first example embodiment. As illustrated in FIG. 1, the processing apparatus 100 includes a status information management unit 110, a consent information management unit 120, and a decision unit 130. The status information management unit 110 manages status information in which a current status of each of management target users is registered. The consent information management unit 120 manages consent information in which determination as to whether to consent to a predetermined consent item is registered for each assumed status in association with each of the management target users. The decision unit 130 determines a current status of a first management target user among the management target users, based on the consent information and the status information, decides whether the first management target user consents to the consent item in a determined status, and issues a predetermined right according to a result of decision.

According to the processing apparatus 100, a user can choose whether to consent to various consent items related to his/her privacy in a more flexible manner (for each assumed status).

### Second Example Embodiment

### “Overview of Processing Apparatus 100”

An overview of a processing apparatus 100 according to a second example embodiment is described.

The processing apparatus 100 manages consent information in which determination as to whether to consent to a predetermined consent item is registered for each assumed status in association with each of management target users. Details on a “predetermined consent item” are described later, but, for example, are “utilization of individual information”, and the like. Details on an “assumed status” are described later, but, for example, are “rescue required”, “search required”, “evacuation required”, “normal”, and the like.

A management target user judges whether to consent to a predetermined consent item, in a case where the user himself/herself is in each assumed status. For example, a management target user judges “whether to consent to utilization of individual information, in a case where the user himself/herself is in a status of rescue required”, “whether to consent to utilization of individual information, in a case where the user himself/herself is in a status of search required”, “whether to consent to utilization of individual information, in a case where the user himself/herself is in a status of evacuation required”, “whether to consent to utilization of individual information, in a case where the user himself/herself is in a normal status”, and the like. Then, the management target user registers a result of judgment in the processing apparatus 100.

Further, the processing apparatus 100 manages status information in which a current status of each of management target users is registered. A current status of a management target user indicated by status information is, for example, “rescue required”, “search required”, “evacuation required”, “normal”, and the like.

Then, the processing apparatus 100 performs predetermined processing, based on the consent information and the status information. Specifically, the processing apparatus 100 determines a current status of a first management target user among management target users, based on the status information.

Subsequently, the processing apparatus 100 decides whether the first management target user consents to a predetermined consent item in a determined status, based on the consent information. Then, the processing apparatus 100 issues a predetermined right according to a result of decision. Specifically, in a case where the first management target user consents to a predetermined consent item in a determined status, the processing apparatus 100 issues a predetermined right. On the other hand, in a case where the first management target user does not consent to a predetermined consent item in a determined status, the processing apparatus 100 does not issue a predetermined right. The predetermined right is related to privacy of the first management target user, and, for example, is a right or the like of utilizing individual information of the first management target user. “Issuance of a predetermined right” is giving a predetermined right to a predetermined subject.

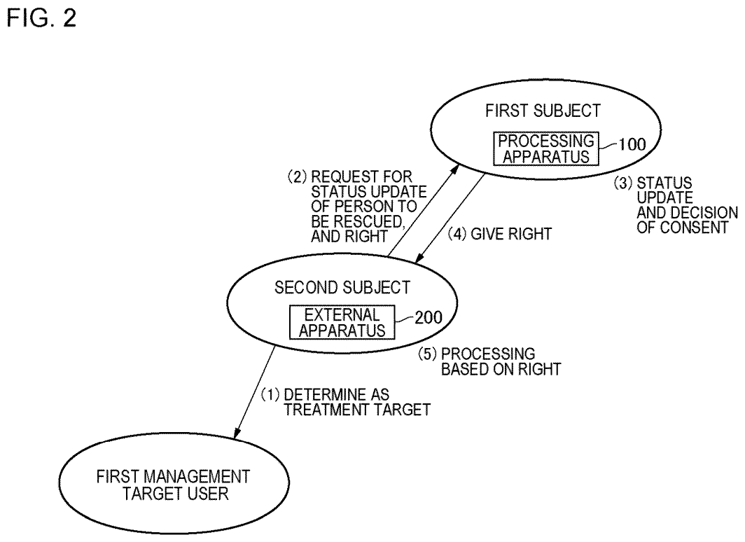

“Overall Image of Processing System 1 including Processing Apparatus 100” Next, an overall image of a processing system 1 including the processing apparatus 100 is described by using FIG. 2. The processing system 1 includes the processing apparatus 100 and an external apparatus 200.

The processing apparatus 100 is managed by a first subject. The first subject is a subject who manages status information and consent information of each of management target users, and issues various rights related to privacy of each management target user according to a status of each management target user. The first subject is assumed to be a country, a group to which the above-described business is entrusted from a country, and the like, but is not limited thereto.

A business of managing status information, a business of managing consent information, and a business of issuing various rights may be performed by one subject, or each business may be performed by an individual subject. In a case where the above three businesses are performed by a plurality of subjects, the processing apparatus 100 is constituted of a plurality of apparatuses that are physically and/or logically separated. Then, each of the plurality of apparatuses includes a part (one apparatus may include two functional units) of a status information management unit 110, a consent information management unit 120, and a decision unit 130, cooperates while communicating with one another, and achieves a function of the processing apparatus 100.

The external apparatus 200 is managed by a second subject. The second subject is a subject who provides various services to a management target user. There is a case that the second subject wishes utilization and the like of individual information of a management target user in order to enrich a service to be provided. The second subject is assumed to be, for example, a fire department for rescuing a person requiring rescue, a police station for searching for a person requiring search, a local government or a local government association for supporting evacuation of a person requiring evacuation, and the like, but is not limited thereto.

An overview of a flow of processing of the processing system 1 is as follows.
(1) The second subject determines, as a treatment target, a first management target user among management target users. The treatment is rescue, search, evacuation support, and the like.
(2) Next, the second subject performs, with respect to the first subject, a request for status update of the first management target user, and issuance of a predetermined right related to the first management target user. The second subject performs the request via the external apparatus 200. The request is transmitted from the external apparatus 200 to the processing apparatus 100. “Status update of the first management target user” is, for example, a change from “normal” to “rescue required”, and the like. A “predetermined right related to the first management target user” is, for example, utilization of individual information, and the like.
(3) Next, the processing apparatus 100 of the first subject updates a status (status information) of the first management target user in response to the request from the second subject. Then, the processing apparatus 100 determines a current status of the first management target user, based on latest status information, and decides, based on consent information, whether the first management target user consents to a predetermined consent item in a determined status.
(4) Next, the processing apparatus 100 of the first subject issues a predetermined right according to a result of the decision of (3), and gives the issued right to the second subject. Giving a right is achieved by transmission of predetermined information from the processing apparatus 100 to the external apparatus 200.
(5) Next, the second subject performs processing, based on the given right.

Note that, a request for status update of the first management target user may not be performed by the second subject, but may be performed by another subject. The another subject is assumed to be, for example, a relative of the first management target user, a person who is registered in advance, and the like.

### “Hardware Configuration”

Next, one example of a hardware configuration of the processing apparatus 100 and the external apparatus 200 is described. Each functional unit of the processing apparatus 100 and the external apparatus 200 is achieved by any combination of hardware and software, mainly including a central processing unit (CPU) of any computer, a memory, a program loaded in a memory, a storage unit (capable of storing, in addition to a program stored in advance at a shipping stage of an apparatus, a program downloaded from a storage medium such as a compact disc (CD), a server on the Internet, and the like) such as a hard disk storing the program, and an interface for network connection. Then, it is understood by a person skilled in the art that there are various modification examples as a method and an apparatus for achieving the configuration.

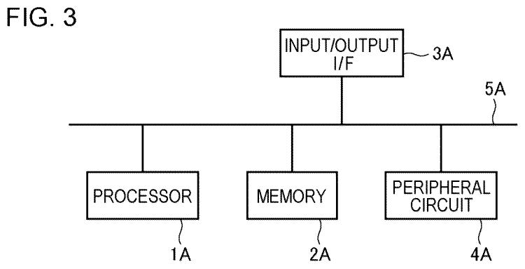

FIG. 3 is a block diagram illustrating the hardware configuration of the processing apparatus 100 and the external apparatus 200. As illustrated in FIG. 3, each of the processing apparatus 100 and the external apparatus 200 includes a processor 1A, a memory 2A, an input/output interface 3A, a peripheral circuit 4A, and a bus 5A. The peripheral circuit 4A includes various modules. Each of the processing apparatus 100 and the external apparatus 200 may not include the peripheral circuit 4A. Note that, each of the processing apparatus 100 and the external apparatus 200 may be constituted of a plurality of apparatuses that are physically and/or logically separated. In this case, each of the plurality of apparatuses can include the above-described hardware configuration.

The bus 5A is a data transmission path along which the processor 1A, the memory 2A, the peripheral circuit 4A, and the input/output interface 3A mutually transmit and receive data. The processor 1A is, for example, an arithmetic processing apparatus such as a CPU and a graphics processing unit (GPU). The memory 2A is, for example, a memory such as a random access memory (RAM) and a read only memory (ROM). The input/output interface 3A includes an interface for acquiring information from an input apparatus, an external apparatus, an external server, an external sensor, a camera, and the like, an interface for outputting information to an output apparatus, an external apparatus, an external server, and the like, and the like. The input apparatus is, for example, a keyboard, a mouse, a microphone, a physical button, a touch panel, and the like. The output apparatus is, for example, a display, a speaker, a printer, a mailer, and the like. The processor 1A can issue a command to each module, and perform an arithmetic operation, based on an arithmetic operation result of each module.

### “Functional Configuration of Processing System 1”

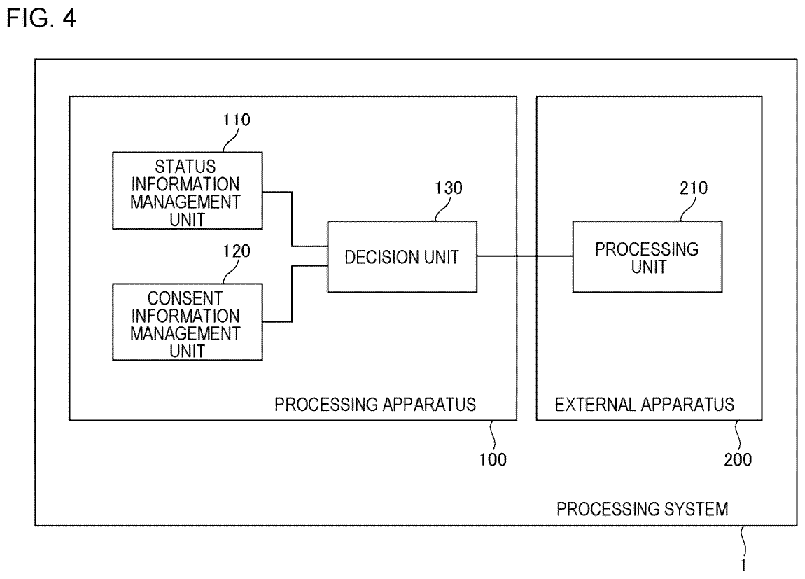

FIG. 4 is one example of a functional block diagram of the processing system 1 according to the second example embodiment. The processing system 1 includes the processing apparatus 100 and the external apparatus 200.

### —Processing Apparatus 100—

As illustrated in FIG. 4, the processing apparatus 100 includes the status information management unit 110, the consent information management unit 120, and the decision unit 130.

The status information management unit 110 manages status information in which a current status of each of management target users is registered. Hereinafter, the above is described in detail.

A “management target user” is a user serving as a target whose status information and consent information are managed.

A “current status” is any of a plurality of assumed statuses defined in advance.

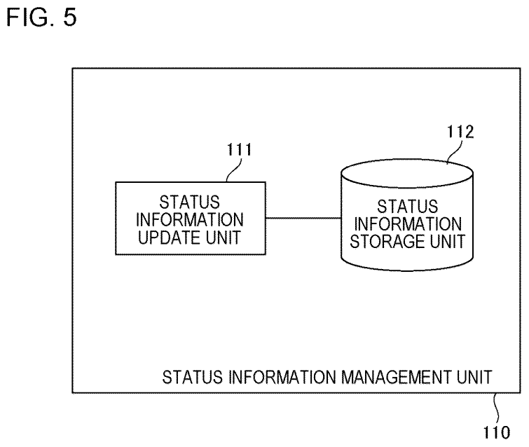

An “assumed status” is a possible status of a management target user, and is a status that may affect a choosing result as to whether to consent to a predetermined consent item. A plurality of statuses are defined in advance as the assumed status. The assumed status is, for example, “rescue required”, “search required”, “evacuation required”, “normal”, and the like, but is not limited thereto. In addition, the assumed status may become more specific, such as a “status in which rescue is requested by call 119”, a “status in which a search request has been filed with a police station”, a “status in which an evacuation advisory has been issued in a place of residence”, and the like. As illustrated in FIG. 5, the status information management unit 110 includes a status information update unit 111 and a status information storage unit 112.

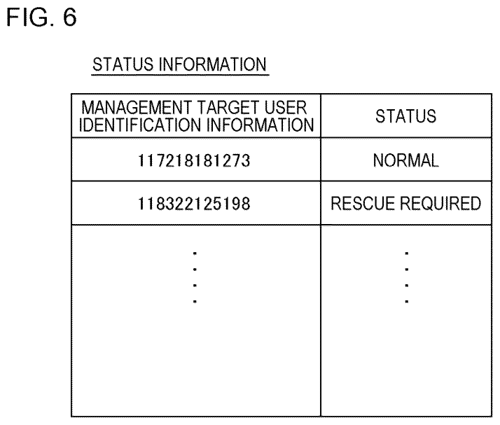

The status information storage unit 112 stores status information in which a current status of each of management target users is registered. FIG. 6 schematically illustrates one example of status information. In the illustrated example, management target user identification information and a current status are associated with each other.

The status information update unit 111 updates a current status of a management target user being registered in status information stored in the status information storage unit 112 in response to a request from a status change request user with a legitimate right.

A “status change request user” is a user who requests update of status information of the first management target user.

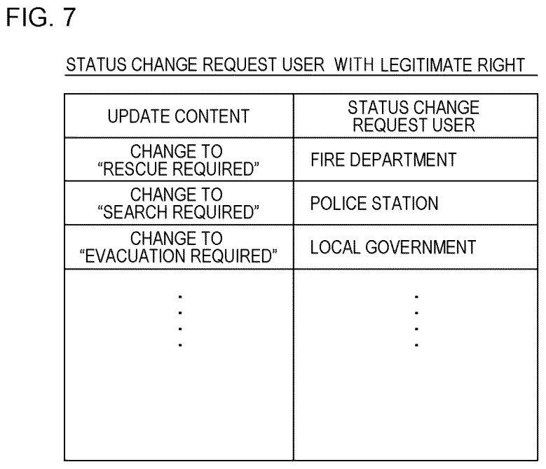

A status change request user with a legitimate right may be different for each update content. For example, it is assumed that a status change user with a legitimate right in a change to “rescue required” is a fire department, a status change user with a legitimate right in a change to “search required” is a police station, and a status change user with a legitimate right in a change to “evacuation required” is a local government and the like in the place of residence of each management target user, but the status change request user is not limited thereto. In this case, as illustrated in FIG. 7, information indicating a status change request user with a legitimate right is registered in advance in the processing apparatus 100 for each update content. Then, the status information update unit 111 decides whether the status change request user has a legitimate right, based on the information.

In addition, a status change request user with a legitimate right may be different for each management target user. Specifically, a status change request user with a legitimate right of updating status information of a first management target user, and a status change request user with a legitimate right of updating status information of a second management target user may be different from each other. For example, a status change request user with a legitimate right of updating status information of the first management target user may be, in addition to the first management target user himself/herself, a status change user registered in advance in association with the first management target user. For example, the first management target user can register, as a status change user with a legitimate right, a relative of the user himself/herself, a supervisor in an office, and the like. Then, the status information update unit 111 decides whether the status change request user has a legitimate right, based on the information.

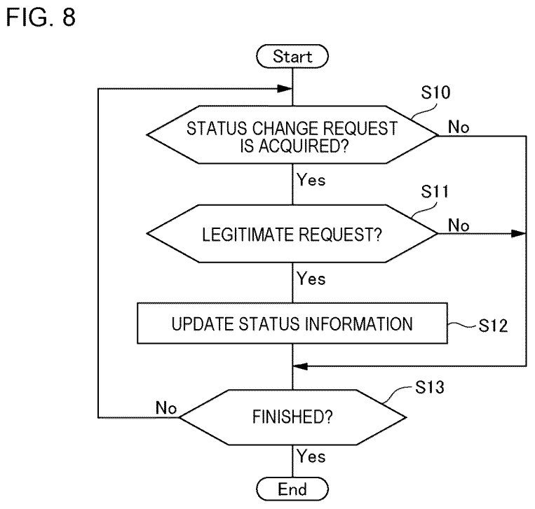

Herein, one example of a flow of processing by the status information update unit 111 is described by using a flowchart in FIG. 8.

First, the status information update unit 111 is waiting for a status change request (S10). The status information update unit 111 receives a status change request from a status change request user via a webpage, an application, or the like.

The status request change to be received includes “information determining a status change request user”, “information determining a management target user being a target whose status information is updated”, and “information indicating a content of a status after update”.

In a case where the status change request is received (Yes in S10), the status information update unit 111 decides whether the status change request is a legitimate request (S11). For example, the status information update unit 111 decides whether a status change request user to be determined by “information determining a status change request user” has a legitimate right of updating status information of a management target user to be determined by “information determining a management target user being a target whose status information is updated” to a content indicated by “information indicating a content of a status after update”, or the like. In this case, in a case where it is decided that the status change request user has a legitimate right, the status information update unit 111 decided that the request is a legitimate request, and in a case where it is decided that the status change request user does not have a legitimate right, the status information update unit 111 decides that the request is not a legitimate request.

Then, in a case where it is decided that the received status change request is a legitimate request (Yes in S11), the status information update unit 111 updates the status information of the management target user to be determined by “information determining a management target user being a target whose status information is updated” to the content indicated by “information indicating a content of a status after update” (S12). On the other hand, in a case where it is decided that the received status change request is not a legitimate request (No in S11), the status information update unit 111 does not perform processing of S12. “Information determining a status change request user” to be acquired in S10 may be, for example, login information on the above-described webpage or application. In this case, a status change request user may log in by utilizing login information (login information associated with an affiliation in the processing apparatus 100) acquired by an affiliation (such as a fire department, a police station, or a local government) of the user himself/herself, and notify the processing apparatus 100 of the affiliation of the user himself/herself by performing the above-described request. In addition, a status change request user may log in by utilizing login information (login information associated with the user himself/herself in the processing apparatus 100) acquired by the user himself/herself, and notify the processing apparatus 100 of identification information of the user himself/herself by performing the above-described request. In this case, the processing apparatus 100 may determine an affiliation of the status change request user, based on information, stored in advance, in which identification information of the status change request user, and the affiliation are associated with each other. Note that, in place of utilization of login information, input of information (such as an affiliation, identification information, a name, an address, a phone number, a birthdate of a user himself/herself) for determining a status change request user may be accepted on an input screen after login.

Further, “information determining a management target user being a target whose status information is updated” to be acquired in S10 may be, for example, an individual number given from a country, or may be combination of pieces of information for determining an individual registered in advance, such as a name, an address, a phone number, and a birthdate.

Referring back to FIG. 4, the consent information management unit 120 manages consent information in which determination as to whether to consent to a predetermined consent item is registered for each assumed status in association with each of management target users. Hereinafter, the above is described in detail.

A “consent item” is, for example, an item related to privacy of each management target user. The consent item may be one or plural. The consent item may include, for example, at least one of a “consent item related to utilization of individual information”, and a “consent item related to determination of a management target user within a surveillance camera image generated by a surveillance camera”. Note that, individual information has a wide variety. For this reason, a “consent item related to utilization of individual information” may be divided into a plurality of items according to a content of individual information, such as a “consent item related to utilization of a first piece of individual information”, and a “consent item related to utilization of a second piece of individual information”. For example, the first piece of individual information is information related to a medical care (such as receipt information or medical record information), and the second piece of individual information is another predetermined piece of information other than the above, and the like.

An “assumed status” is a possible status of a management target user, and is a status that may affect a choosing result as to whether to consent to a predetermined consent item. A plurality of statuses are defined in advance as the assumed status. The assumed status is, for example, “rescue required”, “search required”, “evacuation required”, “normal”, and the like, but is not limited thereto. In addition, the assumed status may become more specific, such as a “status in which rescue is requested by call 119”, a “status in which a search request has been filed with a police station”, a “status in which an evacuation advisory has been issued in a place of residence”, and the like.

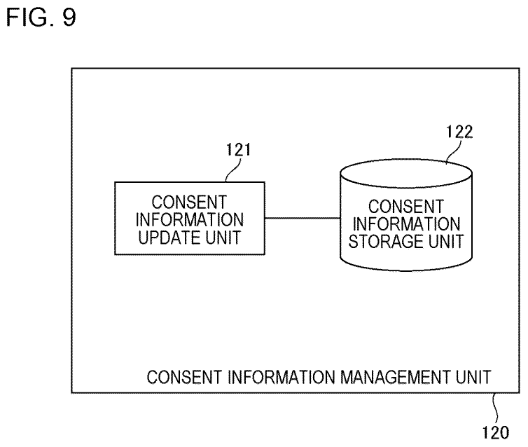

As illustrated in FIG. 9, the consent information management unit 120 includes a consent information update unit 121 and a consent information storage unit 122.

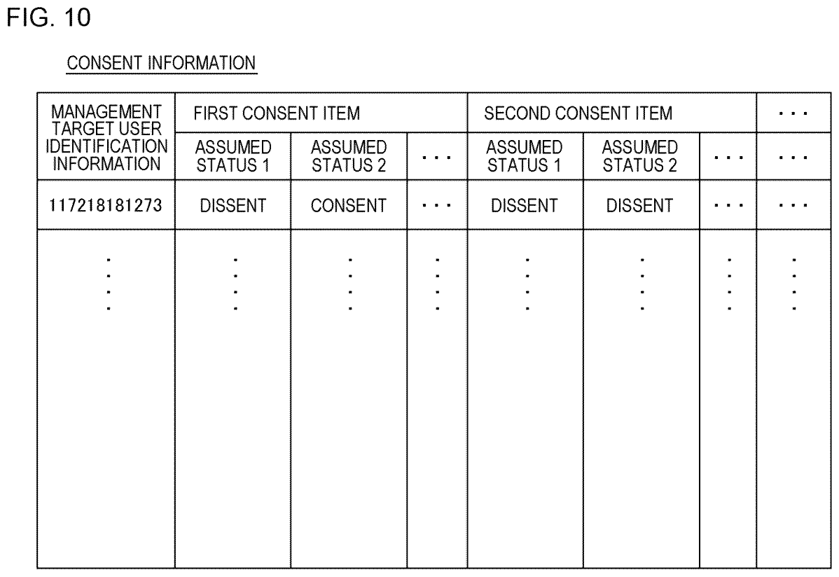

The consent information storage unit 122 stores consent information in which determination as to whether to consent to a predetermined consent item is registered for each assumed status in association with each of management target users. FIG. 10 schematically illustrates one example of consent information. In the illustrated example, management target user identification information, and information indicating whether to consent to each of a plurality of consent items for each assumed status are associated with each other.

Note that, an assumed status may be different for each consent item. For example, a case in which there are two assumed statuses, namely, “normal” and “rescue required” in a first consent item, there are two assumed statuses, namely, “normal” and “search required” in a second consent item. and there are three assumed statuses, namely, “normal”, “rescue required”, and “evacuation required” in a third consent item is exemplified.

The consent information update unit 121 accepts, from a management target user himself/herself, an instruction to register or update consent information via a webpage, an application, or the like. Then, the consent information update unit 121 updates consent information stored in the consent information storage unit 122, based on the user input.

Referring back to FIG. 4, the decision unit 130 determines a current status of a first management target user among management target users, based on the above-described consent information and status information, and decides whether the first management target user consents to a predetermined consent item in a determined status. Then, the decision unit 130 issues a predetermined right according to a result of decision. Hereinafter, the above is described in detail.

The decision unit 130 performs, in response to a request from a right request user with a legitimate right, “determination of a current status of a first management target user”, “decision as to whether a first management target user consents to a predetermined consent item in a determined status”, and “giving a right according to a result of decision”.

A “right request user” is a user who requests for giving a predetermined right related to the first management target user.

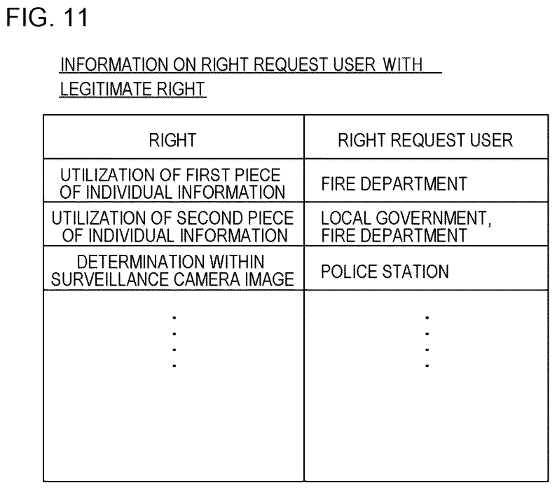

The right request user with a legitimate right may be different for each consent item, specifically, for each right to be given in a case where consent is made. For example, an example is assumed in which a right request user with a legitimate right of requesting “deciding whether a first management target user consents to utilization (consent item) of a first piece of individual information, and giving a right of utilizing the first piece of individual information according to a result of decision” is a fire department, a right request user with a legitimate right of requesting “deciding whether a first management target user consents to utilization (consent item) of a second piece of individual information, and giving a right of utilizing the second piece of individual information according to a result of decision” is a fire department and a local government in the place of residence of each management target user, a right request user with a legitimate right of requesting “deciding whether a first management target user consents to determination (consent item) within a surveillance camera image, and giving a right of performing the determination according to a result of decision” is a police station, and the like, but the present example embodiment is not limited thereto. In this case, as illustrated in FIG. 11, information indicating a right request user with a legitimate right is registered in advance in the processing apparatus 100 for each consent item (specifically, for each right to be given).

Then, the decision unit 130 decides whether the right request user has a legitimate right, based on the information.

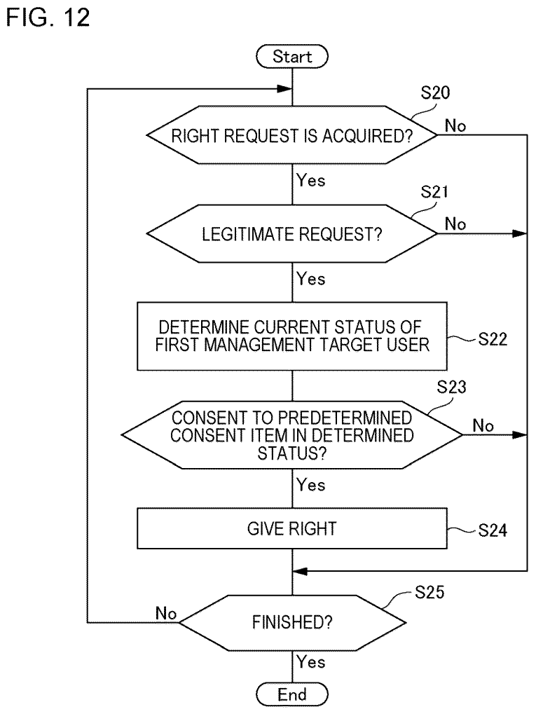

Herein, one example of a flow of processing by the decision unit 130 is described by using a flowchart in FIG. 12.

First, the decision unit 130 is waiting for a right request (S20). The decision unit 130 receives a right request from a right request user via a webpage, an application or the like.

The right request to be received includes “information determining a right request user”, “information determining a right of requesting”, and “information determining a management target user related to the right”.

In a case where the right request is received (Yes in S20), the decision unit 130 decides whether the right request is a legitimate request (S21). For example, the decision unit 130 decides whether a right request user to be determined by “information determining a right request user” has a legitimate right of requesting for giving a right to be determined by “information determining a right of requesting”. In this case, in a case where it is decided that the right request user has a legitimate right, the decision unit 130 decides that the request is a legitimate request, and in a case where it is decided that the right request user does not have a legitimate right, the decision unit 130 determines that the request is not a legitimate request.

Then, in a case where it is decided that the received right request is a legitimate request (Yes in S21), the decision unit 130 decides a current status of the first management target user, based on status information (see FIG. 6) of the first management target user to be determined by “information determining a management target user related to the right” (S22).

Subsequently, the decision unit 130 decides whether the first management target user consents to a consent item related to giving a right to be determined by “information determining a right of requesting” in the status determined in S22, based on the consent information (see FIG. 10) of the first management target user (S23).

In a case where it is decided that the first management target user consents (Yes in S23), the decision unit 130 performs processing of giving a right to be determined by “information determining a right of requesting” to a right request user to be determined by “information determining a right request user” (S24). Specifically, the decision unit 130 transmits, to a terminal of the right request user, information indicating that a predetermined right has been given. Information indicating that a predetermined right has been given may be a one-time password or the like, may be another password, or simply may be text information, image information, or the like indicating that a predetermined right has been given.

On the other hand, in a case where it is decided that the received right request is not a legitimate request (No in S21), the decision unit 130 does not perform pieces of processing from S22 to S24. Further, in a case where it is decided that the first management target user does not consent (No in S23), the decision unit 130 does not perform processing of S24.

“Information determining a right request user” to be acquired in S20 may be, for example, login information of the above-described webpage or application. In this case, a right request user may log in by utilizing login information (login information associated with an affiliation in the processing apparatus 100) acquired by an affiliation (such as a fire department, a police station, or a local government) of the user himself/herself, and notify the processing apparatus 100 of the affiliation of the user himself/herself by performing the above-described request. In addition, a right request user may log in by utilizing login information (login information associated with the user himself/herself in the processing apparatus 100) acquired by the user himself/herself, and notify the processing apparatus 100 of identification information of the user himself/herself by performing the above-described request. In this case, the processing apparatus 100 may determine an affiliation of the right request user, based on information, stored in advance, in which identification information of the right request user, and the affiliation are associated with each other. Note that, in place of utilization of login information, input of information (such as an affiliation, identification information, a name, an address, a phone number, a birthdate of a user himself/herself) for determining a right request user may be accepted on an input screen after login.

Further, “information determining a management target user related to the right” to be acquired in S20 may be, for example, an individual number given from a country, or may be combination of pieces of information for determining an individual registered in advance, such as a name, an address, a phone number, and a birthdate.

Referring back to FIG. 4, a processing unit 210 of the external apparatus 200 performs predetermined processing, based on a predetermined right given by the decision unit 130. As the predetermined processing, a request for a first piece of individual information of a first management target user to a predetermined subject, a request for a second piece of individual information of the first management target user to the predetermined subject, a request for a surveillance camera image to the predetermined subject, a request for analysis of a surveillance camera image (search for a first surveillance target user) to the predetermined subject, and the like are exemplified, but the predetermined processing is not limited thereto.

### Advantageous Effect

The processing apparatus 100 according to the second example embodiment manages consent information in which determination as to whether to consent to a predetermined consent item is registered for each assumed status in association with each of management target users, and also manages status information indicating a current status of each of the management target users. Then, the processing apparatus 100 can decide whether each of the management target users consents to the predetermined consent item in a current status, based on the consent information and the status information, and give various rights related to each of the management target users to a predetermined subject according to a result of decision. According to the processing apparatus 100, a user can choose whether to consent to various consent items related to his/her privacy in a more flexible manner (for each assumed status).

Further, the processing apparatus 100 can update status information indicating a status of a management target user in response to a request from a status change request user with a legitimate right. Configuring as described above enables to suppress an inconvenience that status information is updated inappropriately, and various rights are issued unnecessarily.

Further, the processing apparatus 100 can perform processing of issuing various rights in response to a request from a right request user with a legitimate right. Configuring as described above enables to suppress an inconvenience that various rights are given to an inappropriate target.

### Third Example Embodiment

In a third example embodiment, a usage scene of a processing system 1 are embodied.

### “First Usage Scene”

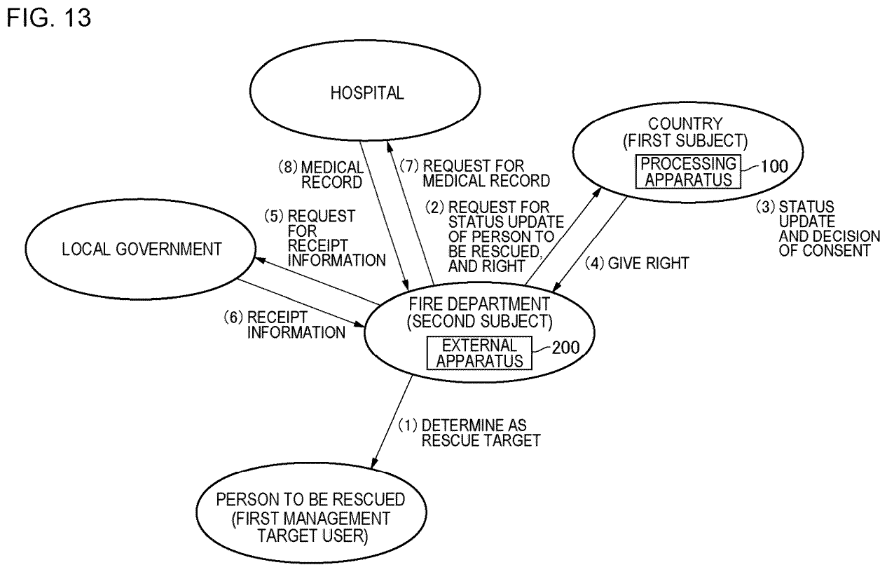

As illustrated in FIG. 13, a first subject that manages a processing apparatus 100 is a country, a group to which a business is entrusted from a country, or the like. A second subject that manages an external apparatus 200 is a fire department.

An overview of a flow of processing by the processing system 1 is as follows.
(1) A fire department determines, as a treatment target, a first management target user from among management target users. The treatment is rescue, and the first management target user being a treatment target is a person to be rescued. For example, a person who asks for rescue by call 119, or a person who suffers from damage at a scene such as an accident or a disaster, and needs rescue becomes a person to be rescued. Then, the fire department acquires information (such as management target user identification information, or combination of pieces of information for determining an individual registered in advance, such as a name, an address, a phone number, and a birthdate) for determining the person to be rescued. For example, the fire department may ask a person himself/herself to be rescued, his/her attendant, or the like for information determining the person to be rescued, or may find, from belongings of the person to be rescued, information determining the person to be rescued.
(2) Next, the fire department performs, with respect to the first subject, a request for status update of the person to be rescued, and issuance of a predetermined right related to the person to be rescued. Status update of the person to be rescued is, for example, a change to “rescue required”. A predetermined right is a right of utilizing a first piece of individual information (information related to a medical care (such as receipt information or medical record information)) of the person to be rescued. Specifically, the fire department operates the external apparatus 200, and transmits, to the processing apparatus 100, a status change request and a right request. For example, it is assumed that an emergency personnel of the fire department performs pieces of processing (2) to (8) during a time when the emergency personnel rushes to the person to be rescued by an ambulance, during a time when the emergency personnel performs treatment to the person to be rescued on site, during a time when the emergency personnel transports the person to be rescued to a predetermined hospital by an ambulance, or the like.
(3) Next, the processing apparatus 100 updates a status (status information) of the person to be rescued (first management target user) in response to the request from the fire department. For example, the processing apparatus 100 changes the status of the person to be rescued to “rescue required”. Then, the processing apparatus 100 determines a current status of the person to be rescued, based on latest status information, and also decides whether the person to be rescued consents to a predetermined consent item in a determined status, based on consent information. Herein, a consent item to be decided is “utilization of a first piece of individual information”. Details on these pieces of processing by the processing apparatus 100 are as described in the second example embodiment.
(4) Next, the processing apparatus 100 issues a predetermined right according to a result of the decision of (3), and gives the issued right to the fire department. Specifically, the processing apparatus 100 transmits, to the external apparatus 200, information indicating that a predetermined right has been given. The predetermined right is a right of utilizing a first piece of individual information (information related to a medical care (such as receipt information or medical record information)) of the person to be rescued. Details on these pieces of processing by the processing apparatus 100 are as described in the second example embodiment.
(5) Next, the fire department requests receipt information of the person to be rescued to a local government in a place of residence of the person to be rescued, based on the given right.
(6) Next, the local government in the place of residence of the person to be rescued presents the receipt information of the person to be rescued to the fire department in response to the request of (5).

The pieces of communication of (5) and (6) may be achieved by communication of data between a computer to be managed by the local government, and a computer to be managed by the fire department. For example, the communication may be achieved by processing via a webpage or an application provided by the local government. In addition, the pieces of communication of (5) and (6) may be achieved by dialogue between persons by phone, fax, an e-mail, or the like.

Note that, in the pieces of communication of (5) and (6), it is preferable that the fire department indicates to the local government that the predetermined right has been given to the fire department, and also the local government confirms that the predetermined right has been given to the fire department. There are various means for achieving these, and the above can be achieved by utilizing any technique. For example, presentation of “information indicating that a predetermined right has been given” being transmitted from the processing apparatus 100, and the like are conceived as one example.
(7) Next, the fire department recognizes, based on the acquired receipt information, a medical history or a primary care doctor of the person to be rescued, a hospital to which the person to be rescued went recently, and the like. Then, the fire department requests the predetermined hospital for a medical record of the person to be rescued, based on the recognized content.
(8) Next, the hospital presents the medical record of the person to be rescued to the fire department in response to the request (7).

The pieces of communication of (7) and (8) may be achieved by communication of data between a computer to be managed by the hospital, and a computer to be managed by the fire department. For example, the communication may be achieved by processing via a webpage or an application provided by the hospital. In addition, the pieces of communication of (7) and (8) may be achieved by dialogue between persons by phone, fax, an e-mail, or the like.

Note that, in the pieces of communication of (7) and (8), it is preferable that the fire department indicates to the hospital that the predetermined right has been given to the fire department, and also the hospital confirms that the predetermined right has been given to the fire department. There are various means for achieving these, and the above can be achieved by utilizing any technique. For example, presentation of “information indicating that a predetermined right has been given” being transmitted from the processing apparatus 100, and the like are conceived as one example.

The fire department can recognize, based on the acquired medical record, a chronic disease, a recent medical history, a health state, and the like of the person to be rescued, and perform proper treatment according to the recognized content. Further, the fire department can present these pieces of information to the hospital being a transport destination.

### “Second Usage Scene”

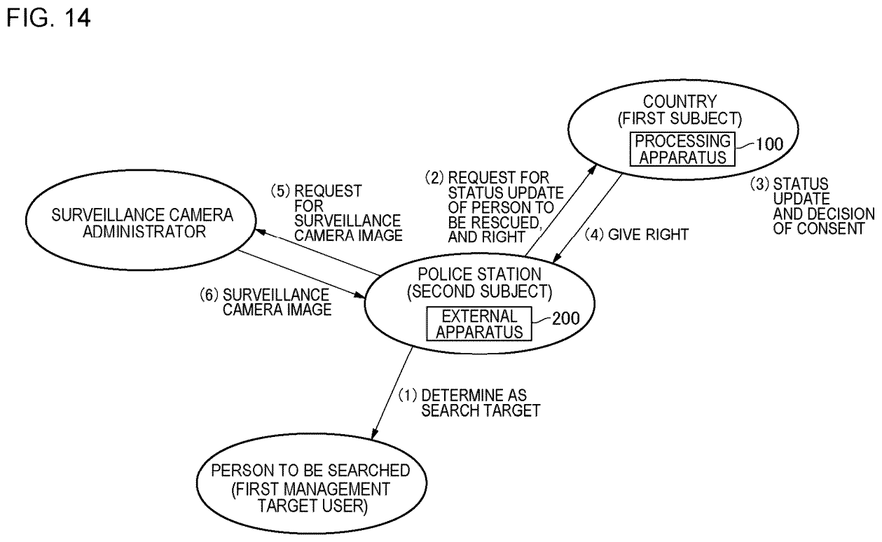

As illustrated in FIG. 14, a first subject that manages the processing apparatus 100 is a country, a group to which a business is entrusted from a country, or the like. A second subject that manages the external apparatus 200 is a police station.

An overview of a flow of processing by the processing system 1 is as follows.
(1) A police station determines, as a treatment target, a first management target user from among management target users. The treatment is search, and the first management target user being a treatment target is a person to be searched, who becomes a missing person, a lost child, or the like. For example, a person and the like for whom a search request has been filed becomes a person to be searched. Then, the police station acquires information (such as management target user identification information, or combination of pieces of information for determining an individual registered in advance, such as a name, an address, a phone number, and a birthdate) for determining the person to be searched. For example, the police station may ask a relative or an acquaintance of the person to be searched, a person who has filed a search request, or the like for information determining the person to be searched, or may find, from belongings of the person to be searched, information determining the person to be searched.
(2) Next, the police station performs, with respect to the first subject, a request for status update of the person to be searched, and issuance of a predetermined right related to the person to be searched. Status update of the person to be searched is, for example, a change to “search required”. A predetermined right is a right of determining the person to be searched within a surveillance camera image. Specifically, the police station operates the external apparatus 200, and transmits, to the processing apparatus 100, a status change request and a right request.
(3) Next, the processing apparatus 100 updates a status (status information) of the person to be searched (first management target user) in response to the request from the police station. For example, the processing apparatus 100 changes the status of the person to be searched to “search required”. Then, the processing apparatus 100 determines a current status of the person to be searched, based on latest status information, and also decides whether the person to be searched consents to a predetermined consent item in a determined status, based on consent information. Herein, a consent item to be decided is “determination within a surveillance camera image”. Details on these pieces of processing by the processing apparatus 100 are as described in the second example embodiment.
(4) Next, the processing apparatus 100 issues a predetermined right according to a result of the decision of (3), and gives the issued right to the police station. Specifically, the processing apparatus 100 transmits, to the external apparatus 200, information indicating that a predetermined right has been given. The predetermined right is a right of determining the person to be searched within a surveillance camera image. Details on these pieces of processing by the processing apparatus 100 are as described in the second example embodiment.
(5) Next, the police station requests a surveillance camera administrator for a surveillance camera image, based on the given right. The surveillance camera administrator manages a surveillance camera, and possesses a surveillance camera image generated by the surveillance camera.
(6) Next, the surveillance camera administrator presents the surveillance camera image to the police station in response to the request of (5).

The pieces of communication of (5) and (6) may be achieved by communication of data between a computer to be managed by the surveillance camera administrator, and a computer to be managed by the police station. For example, the communication may be achieved by processing via a webpage or an application provided by the surveillance camera administrator. In addition, the pieces of communication of (5) and (6) may be achieved by dialogue between persons by phone, fax, an e-mail, or the like.

Note that, in the pieces of communication of (5) and (6), it is preferable that the police station indicates to the surveillance camera administrator that the predetermined right has been given to the police station, and also the surveillance camera administrator confirms that the predetermined right has been given to the police station. There are various means for achieving these, and the above can be achieved by utilizing any technique. For example, presentation of “information indicating that a predetermined right has been given” being transmitted from the processing apparatus 100, and the like are conceived as one example.

Thereafter, the police station analyzes the surveillance camera image provided from the surveillance camera administrator, and searches for the person to be searched within the surveillance camera image.

### “Third Usage Scene”

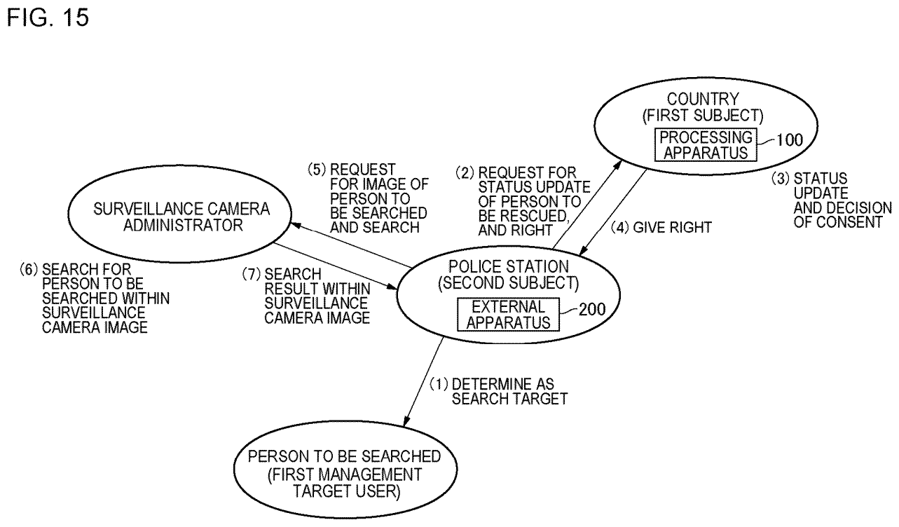

As illustrated in FIG. 15, a first subject that manages the processing apparatus 100 is a country, a group to which a business is entrusted from a country, or the like. A second subject that manages the external apparatus 200 is a police station.

An overview of a flow of processing by the processing system 1 is as follows.
(1) A police station determines, as a treatment target, a first management target user from among management target users. The treatment is search, and the first management target user being a treatment target is a person to be searched, who becomes a missing person, a lost child, or the like. For example, a person and the like for whom a search request has been filed becomes a person to be searched. Then, the police station acquires information (such as management target user identification information, or combination of pieces of information for determining an individual registered in advance, such as a name, an address, a phone number, and a birthdate) for determining the person to be searched. For example, the police station may ask a relative or an acquaintance of the person to be searched, a person who has filed a search request, or the like for information determining the person to be searched, or may find, from belongings of the person to be searched, information determining the person to be searched.
(2) Next, the police station performs, with respect to the first subject, a request for status update of the person to be searched, and issuance of a predetermined right related to the person to be searched. Status update of the person to be searched is, for example, a change to “search required”. A predetermined right is a right of determining the person to be searched within a surveillance camera image. Specifically, the police station operates the external apparatus 200, and transmits, to the processing apparatus 100, a status change request and a right request.
(3) Next, the processing apparatus 100 updates a status (status information) of the person to be searched (first management target user) in response to the request from the police station. For example, the processing apparatus 100 changes the status of the person to be searched to “search required”. Then, the processing apparatus 100 determines a current status of the person to be searched, based on latest status information, and also decides whether the person to be searched consents to a predetermined consent item in a determined status, based on consent information. Herein, a consent item to be decided is “determination within a surveillance camera image”. Details on these pieces of processing by the processing apparatus 100 are as described in the second example embodiment.
(4) Next, the processing apparatus 100 issues a predetermined right according to a result of the decision of (3), and gives the issued right to the police station. Specifically, the processing apparatus 100 transmits, to the external apparatus 200, information indicating that a predetermined right has been given. The predetermined right is a right of determining the person to be searched within a surveillance camera image. Details on these pieces of processing by the processing apparatus 100 are as described in the second example embodiment.
(5) Next, the police station requests a surveillance camera administrator for searching for the person to be searched within a surveillance camera image, based on the given right. In the request, the police station presents an image of the person to be searched to the surveillance camera administrator. The surveillance camera administrator manages a surveillance camera, and possesses a surveillance camera image generated by the surveillance camera. The request may be achieved by communication of data between a computer to be managed by the surveillance camera administrator, and a computer to be managed by the police station. For example, the communication may be achieved by processing via a webpage or an application provided by the surveillance camera administrator. In addition, the request may be achieved by dialogue between persons by phone, fax, an e-mail, or the like.

Note that, in the request, it is preferable that the police station indicates to the surveillance camera administrator that the predetermined right has been given to the police station, and also the surveillance camera administrator confirms that the predetermined right has been given to the police station. There are various means for achieving these, and the above can be achieved by utilizing any technique. For example, presentation of “information indicating that a predetermined right has been given” being transmitted from the processing apparatus 100, and the like are conceived as one example.
(6) Next, the surveillance camera administrator searches for the person to be searched within the possessed surveillance camera image in response to the request of (5). The search is achieved by utilizing any image analysis technique.
(7) Next, the surveillance camera administrator presents a result of the search of (6) to the police station. Presentation of the result may be achieved by communication of data between a computer to be managed by the surveillance camera administrator, and a computer to be managed by the police station. For example, the communication may be achieved by processing via a webpage or an application provided by the surveillance camera administrator. In addition, presentation of the result may be achieved by dialogue between persons by phone, fax, an e-mail, or the like.

### “Fourth Usage Scene”

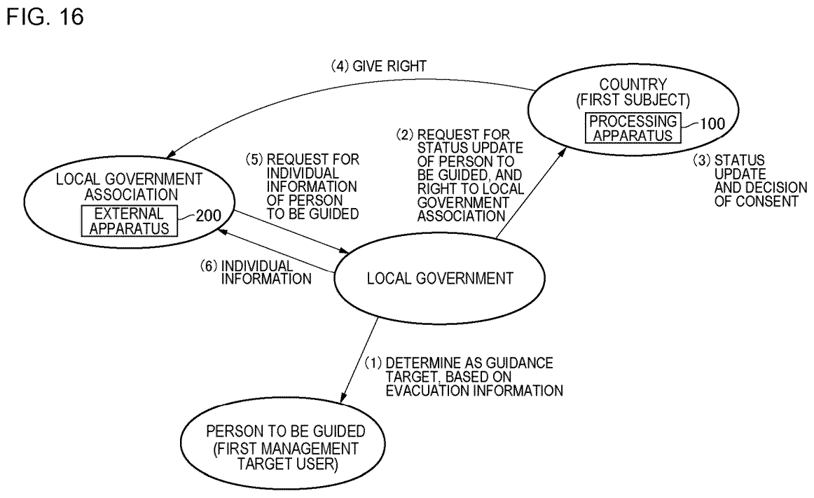

As illustrated in FIG. 16, a first subject that manages the processing apparatus 100 is a country, a group to which a business is entrusted from a country, or the like. A second subject that manages the external apparatus 200 is a local government association. An overview of a flow of processing by the processing system 1 is as follows.
(1) A local government issues an evacuation advisory or the like to a resident in a predetermined area at a time of occurrence of a disaster or the like. The local government is an administrative agency for supervising a region. Then, the local government determines, as a treatment target, a first management target user from among management target users. The treatment is evacuation guidance, and the first management target user being a treatment target is a resident in an area where an evacuation advisory or the like has been issued, or a resident who satisfies a predetermined condition (e.g.: age over 80 years old) among residents in an area where an evacuation advisory or the like has been issued. Then, the local government acquires information (such as management target user identification information, or combination of pieces of information for determining an individual registered in advance, such as a name, an address, a phone number, and a birthdate) for determining a person to be guided, based on resident information being managed.
(2) Next, the local government performs, with respect to the first subject, a request for status update of the person to be guided, and issuance of a predetermined right related to the person to be guided. Status update of the person to be guided is, for example, a change to “guidance required”. A predetermined right is a right of utilizing a first piece of individual information (information related to a medical care (such as receipt information or medical record information)) of the person to be guided. Specifically, the local government operates a predetermined computer, and transmits, to the processing apparatus 100, a status change request and a right request. By the way, in the example, the local government requests for giving the above-described predetermined right to not a local government but a local government association. A local government association is a group formed of residents in a partial area of an area to be supervised by a local government, and performs various businesses associated with the partial area. In the example, the local government association performs evacuation guidance of the person to be guided.
(3) Next, the processing apparatus 100 updates a status (status information) of the person to be guided (first management target user) in response to the request from the local government. For example, the processing apparatus 100 changes the status of the person to be guided to “guidance required”. Then, the processing apparatus 100 determines a current status of the person to be guided, based on latest status information, and also decides whether the person to be guided consents to a predetermined consent item in a determined status, based on consent information. Herein, a consent item to be decided is “utilization of a first piece of individual information”. Details on these pieces of processing by the processing apparatus 100 are as described in the second example embodiment.
(4) Next, the processing apparatus 100 issues a predetermined right according to a result of the decision of (3), and gives the issued right to the local government association. Specifically, the processing apparatus 100 transmits, to the external apparatus 200, information indicating that a predetermined right has been given. For example, at a time of the right request of (2), the local government may notify the processing apparatus 100 of a transmission destination of “information indicating that a predetermined right has been given”. The predetermined right is a right of utilizing a first piece of individual information (information related to a medical care (such as receipt information or medical record information)) of the person to be guided. Details on these pieces of processing by the processing apparatus 100 are as described in the second example embodiment.
(5) Next, the local government association requests receipt information of the person to be guided to the local government in a place of residence of the person to be guided, based on the given right.
(6) Next, the local government in the place of residence of the person to be guided presents the receipt information of the person to be guided to the local government association in response to the request of (5).

The pieces of communication of (5) and (6) may be achieved by communication of data between a computer to be managed by the local government, and a computer to be managed by the local government association. For example, the communication may be achieved by processing via a webpage or an application provided by the local government. In addition, the pieces of communication of (5) and (6) may be achieved by dialogue between persons by phone, fax, an e-mail, or the like.

Note that, in the pieces of communication of (5) and (6), it is preferable that the local government association indicates to the local government that the predetermined right has been given to the local government association, and also the local government confirms that the predetermined right has been given to the local government association. There are various means for achieving these, and the above can be achieved by utilizing any technique. For example, presentation of “information indicating that a predetermined right has been given” being transmitted from the processing apparatus 100, and the like are conceived as one example.

Thereafter, the local government association recognizes a medical history or the like of the person to be guided, based on the acquired receipt information. Then, the local government association determines an appropriate evacuation destination, and guides the person to be guided to the determined evacuation destination.

Although not illustrated, thereafter, the local government association may report to the local government that evacuation of the person to be guided has been completed, and the evacuation destination. Then, the local government may report to the country that evacuation of the person to be guided has been completed, and the evacuation destination.

Subsequently, the local government may request the processing apparatus 100 for giving a right of utilizing a first piece of individual information (information related to a medical care (such as receipt information or medical record information)) of the person to be guided to a group supporting an evacuated person at the evacuation destination of the person to be guided. Then, the group to which the right has been given can recognize necessary supplies and support, based on the first piece of individual information of the person to be guided.

Other configurations of the processing system 1 according to the third example embodiment are similar to the configurations of the processing system 1 according to the first and second example embodiments. In the processing system 1 according to the third example embodiment, an advantageous effect similar to that of the processing system 1 according to the first and second example embodiments is achieved.

In the foregoing, example embodiments according to the present invention have been described with reference to the drawings, however, these are examples of the present invention, and various configurations other than the above can also be adopted.

Further, in a plurality of flowcharts used in the above description, a plurality of processes (pieces of processing) are described in order, however, an order of execution of processes to be performed in each example embodiment is not limited to the order of description. In each example embodiment, the illustrated order of processes can be changed within a range that does not adversely affect a content. Further, the above-described example embodiments can be combined, as far as contents do not conflict with each other.

A part or all of the above-described example embodiments may also be described as the following supplementary notes, but is not limited to the following.
1. A processing apparatus including:
   a status information management unit that manages status information in which a current status of each of management target users is registered;
   a consent information management unit that manages consent information in which determination as to whether to consent to a predetermined consent item is registered for each assumed status in association with each of the management target users; and
   a decision unit that determines a current status of a first management target user among the management target users, based on the consent information and the status information, decides whether the first management target user consents to the consent item in a determined status, and issues a predetermined right according to a result of decision.
2. The processing apparatus according to supplementary note 1, wherein
   the consent item includes a first consent item related to utilization of a first piece of individual information of the management target user, and
   the decision unit
      decides whether the first management target user consents to the first consent item in a current status in response to a request from a right request user, and,
      in a case where it is decided that the first management target user consents to the first consent item in a current status, performs processing of issuing a right of utilizing the first piece of individual information of the first management target user.
3. The processing apparatus according to supplementary note 2, wherein
   the consent item includes, in addition to the first consent item, a second consent item related to utilization of a second piece of individual information of the management target user, and,
   in the consent information, determination as to whether to consent to the first consent item and the second consent item individually is registered for each of the assumed statuses.
4. The processing apparatus according to any one of supplementary notes 1 to 3, wherein
   the consent item includes a third consent item related to determination of the management target user within a surveillance camera image generated by a surveillance camera, and
   the decision unit
      decides whether the first management target user consents to the third consent item in a current status in response to a request from a right request user, and,
      in a case where it is decided that the first management target user consents to the third consent item in a current status, performs processing of issuing a right of determining the first management target user within the surveillance camera image.
5. The processing apparatus according to any one of supplementary notes 1 to 4, wherein
   the consent information indicates whether to consent to each of a plurality of the consent items for each of the assumed statuses, and
   the assumed status is different for each of the consent items.
6. The processing apparatus according to any one of supplementary notes 1 to 5, wherein,
   in the consent information, determination as to whether to consent to each of a plurality of the consent items is registered for each of the assumed statuses,
   the decision unit decides whether the first management target user consents to the consent item in a current status in response to a request from a right request user with a legitimate right,
   the right request user with a legitimate right is different for each of the consent items, and the decision unit decides whether the right request user has a legitimate right, based on information indicating the right request user with a legitimate right for each of the consent items.
7. The processing apparatus according to any one of supplementary notes 1 to 6, wherein
   the status information management unit updates a current status of the management target user registered in the status information in response to a request from a status change request user with a legitimate right,
   the status change request user with a legitimate right is different for each update content, and
   the decision unit decides whether the status change request user has a legitimate right, based on information indicating the status change request user with a legitimate right for each update content.
8. A processing method including,
   by a computer:
      managing status information in which a current status of each of management target users is registered;
      managing consent information in which determination as to whether to consent to a predetermined consent item is registered for each assumed status in association with each of the management target users; and
      determining a current status of a first management target user among the management target users, based on the consent information and the status information, deciding whether the first management target user consents to the consent item in a determined status, and issuing a predetermined right according to a result of decision.
9. A storage medium storing a program causing a computer to function as:
   a status information management unit that manages status information in which a current status of each of management target users is registered;
   a consent information management unit that manages consent information in which determination as to whether to consent to a predetermined consent item is registered for each assumed status in association with each of the management target users; and
   a decision unit that determines a current status of a first management target user among the management target users, based on the consent information and the status information, decides whether the first management target user consents to the consent item in a determined status, and issues a predetermined right according to a result of decision.
10. A processing system including:
   a status information management unit that manages status information in which a current status of each of management target users is registered;
   a consent information management unit that manages consent information in which determination as to whether to consent to a predetermined consent item is registered for each assumed status in association with each of the management target users;
   a decision unit that decides whether a first management target user among the management target users consents to the consent item in a current status, based on the consent information and the status information, and issues a predetermined right according to a result of decision; and
   a processing unit that performs predetermined processing, based on the predetermined right.

### REFERENCE SIGNS LIST

100 Processing apparatus
110 Status information management unit
111 Status information update unit
112 Status information storage unit
120 Consent information management unit
121 Consent information update unit
122 Consent information storage unit
130 Decision unit
200 External apparatus
210 Processing unit
1A Processor
2A Memory
3 A Input/output I/F
4A Peripheral circuit
A Bus

What is claimed is:

1. A processing apparatus comprising:
at least one memory configured to store one or more instructions; and
at least one processor configured to execute the one or more instructions to:
manage status information in which a current status of each of management target users is registered;
manage consent information in which determination as to whether to consent to a predetermined consent item is registered for each assumed status in association with each of the management target users; and
determine a current status of a first management target user among the management target users, based on the consent information and the status information, decide whether the first management target user consents to the consent item in a determined status, and issue a predetermined right according to a result of decision.

2. The processing apparatus according to claim 1, wherein
the consent item includes a first consent item related to utilization of a first piece of individual information of the management target user, and
the at least one processor is further configured to execute the one or more instructions to
decide whether the first management target user consents to the first consent item in a current status in response to a request from a right request user, and,
in a case where it is decided that the first management target user consents to the first consent item in a current status, perform processing of issuing a right of utilizing the first piece of individual information of the first management target user.

3. The processing apparatus according to claim 2, wherein
the consent item includes, in addition to the first consent item, a second consent item related to utilization of a second piece of individual information of the management target user, and,
in the consent information, determination as to whether to consent to the first consent item and the second consent item individually is registered for each of the assumed statuses.

4. The processing apparatus according to claim 1, wherein
the consent item includes a third consent item related to determination of the management target user within a surveillance camera image generated by a surveillance camera, and
the at least one processor is further configured to execute the one or more instructions to
decide whether the first management target user consents to the third consent item in a current status in response to a request from a right request user, and,
in a case where it is decided that the first management target user consents to the third consent item in a current status, perform processing of issuing a right of determining the first management target user within the surveillance camera image.

5. The processing apparatus according to claim 1, wherein
the consent information indicates whether to consent to each of a plurality of the consent items for each of the assumed statuses, and
the assumed status is different for each of the consent items.

6. The processing apparatus according to claim 1, wherein,
in the consent information, determination as to whether to consent to each of a plurality of the consent items is registered for each of the assumed statuses,
the at least one processor is further configured to execute the one or more instructions to decide whether the first management target user consents to the consent item in a current status in response to a request from a right request user with a legitimate right,
the right request user with a legitimate right is different for each of the consent items, and
the at least one processor is further configured to execute the one or more instructions to decide whether the right request user has a legitimate right, based on information indicating the right request user with a legitimate right for each of the consent items.

7. The processing apparatus according to claim 1, wherein
the at least one processor is further configured to execute the one or more instructions to update a current status of the management target user registered in the status information in response to a request from a status change request user with a legitimate right,
the status change request user with a legitimate right is different for each update content, and
the at least one processor is further configured to execute the one or more instructions to decide whether the status change request user has a legitimate right, based on information indicating the status change request user with a legitimate right for each update content.

8. A processing method comprising,
by a computer:
managing status information in which a current status of each of management target users is registered;
managing consent information in which determination as to whether to consent to a predetermined consent item is registered for each assumed status in association with each of the management target users; and
determining a current status of a first management target user among the management target users, based on the consent information and the status information, deciding whether the first management target user consents to the consent item in a determined status, and issuing a predetermined right according to a result of decision.

9. (canceled)

10. A processing system comprising:
at least one memory configured to store one or more instructions; and
at least one processor configured to execute the one or more instructions to:
manage status information in which a current status of each of management target users is registered;
manage consent information in which determination as to whether to consent to a predetermined consent item is registered for each assumed status in association with each of the management target users;
decide whether a first management target user among the management target users consents to the consent item in a current status, based on the consent information and the status information, and issue a predetermined right according to a result of decision; and
perform predetermined processing, based on the predetermined right.

11. The processing method according to claim 8, wherein
the consent item includes a first consent item related to utilization of a first piece of individual information of the management target user, and
the computer
decides whether the first management target user consents to the first consent item in a current status in response to a request from a right request user, and,
in a case where it is decided that the first management target user consents to the first consent item in a current status, performs processing of issuing a right of utilizing the first piece of individual information of the first management target user.

12. The processing method according to claim 11, wherein
the consent item includes, in addition to the first consent item, a second consent item related to utilization of a second piece of individual information of the management target user, and,
in the consent information, determination as to whether to consent to the first consent item and the second consent item individually is registered for each of the assumed statuses.

13. The processing method according to claim 8, wherein
the consent item includes a third consent item related to determination of the management target user within a surveillance camera image generated by a surveillance camera, and
the computer
decides whether the first management target user consents to the third consent item in a current status in response to a request from a right request user, and,
in a case where it is decided that the first management target user consents to the third consent item in a current status, performs processing of issuing a right of determining the first management target user within the surveillance camera image.

14. The processing method according to claim 8, wherein
the consent information indicates whether to consent to each of a plurality of the consent items for each of the assumed statuses, and
the assumed status is different for each of the consent items.

15. The processing system according to claim 10, wherein
the consent item includes a first consent item related to utilization of a first piece of individual information of the management target user, and
the at least one processor is further configured to execute the one or more instructions to
decide whether the first management target user consents to the first consent item in a current status in response to a request from a right request user, and,
in a case where it is decided that the first management target user consents to the first consent item in a current status, perform processing of issuing a right of utilizing the first piece of individual information of the first management target user.

16. The processing system according to claim 15, wherein
the consent item includes, in addition to the first consent item, a second consent item related to utilization of a second piece of individual information of the management target user, and,
in the consent information, determination as to whether to consent to the first consent item and the second consent item individually is registered for each of the assumed statuses.

17. The processing system according to claim 10, wherein
the consent item includes a third consent item related to determination of the management target user within a surveillance camera image generated by a surveillance camera, and
the at least one processor is further configured to execute the one or more instructions to
decide whether the first management target user consents to the third consent item in a current status in response to a request from a right request user, and,
in a case where it is decided that the first management target user consents to the third consent item in a current status, perform processing of issuing a right of determining the first management target user within the surveillance camera image.

18. The processing system according to claim 10, wherein
the consent information indicates whether to consent to each of a plurality of the consent items for each of the assumed statuses, and
the assumed status is different for each of the consent items.

19. The processing system according to claim 10, wherein,
in the consent information, determination as to whether to consent to each of a plurality of the consent items is registered for each of the assumed statuses,
the at least one processor is further configured to execute the one or more instructions to decide whether the first management target user consents to the consent item in a current status in response to a request from a right request user with a legitimate right,
the right request user with a legitimate right is different for each of the consent items, and
the at least one processor is further configured to execute the one or more instructions to decide whether the right request user has a legitimate right, based on information indicating the right request user with a legitimate right for each of the consent items.

20. The processing system according to claim 10, wherein
the at least one processor is further configured to execute the one or more instructions to update a current status of the management target user registered in the status information in response to a request from a status change request user with a legitimate right,
the status change request user with a legitimate right is different for each update content, and
the at least one processor is further configured to execute the one or more instructions to decide whether the status change request user has a legitimate right, based on information indicating the status change request user with a legitimate right for each update content.
